(19) United States
(12) Patent Application Publication
(10) Pub. No.: US 2014/0074276 A1
(43) Pub. Date: Mar. 13, 2014

(54) METHOD AND SYSTEM FOR BAY TYPICAL BASED IEC 61850 ENGINEERING AND INTEGRATION

(71) Applicant: ABB Technology AG, Zurich (CH)

(72) Inventors: Lars LIBUDA, Heidelberg (DE); Horst BÜKER, Minden (DE); Peter ERNING, Bruhl (DE)

(73) Assignee: ABB Technology AG, Zurich (CH)

(21) Appl. No.: 14/021,312

(22) Filed: Sep. 9, 2013

(30) Foreign Application Priority Data
Sep. 7, 2012 (EP) 12006303.7

(51) Int. Cl. G05B 15/02

(52) U.S. Cl. CPC G05B 15/02
USPC 700/112

(57) ABSTRACT

A method and system are provided for bay typical based IEC 61850 engineering and integration to be used in an automation plant. Functional parts of each bay typical are distributed across tools by using unique identifiers. An identification of a tool's specific functional part of a bay typical is based on the unique identifier.

### RELATED APPLICATION

This application claims priority under 35 U.S.C. §119 to European Patent Application No. 12006303.7 filed in Europe on Sep. 7, 2012, the entire content of which is hereby incorporated by reference in its entirety.

### FIELD

The present disclosure relates to a method for bay typical based IEC 61850 engineering and integration, used in an automation plant, and is provided to distribute functional parts of each bay typical across tools by using unique identifiers. the present disclosure also relates to a system using the method for bay typical based IEC 61850 engineering and integration.

### BACKGROUND INFORMATION

In the process automation and power generation businesses, the engineering of the automation solutions based on the standard IEC 61850 for integrated process and power automation by using control and protection devices, also called Intelligent Electronic Devices (IED), and these devices need to be connected to a central automation system for data exchange.

IEC 61850 is an Ethernet-based international standard for communication in the power generation facilities and electric power transformation substations to integrate all of the protection, control, measurement and monitoring functions within a substation or a sub-network, and to provide the intelligent electronic devices for the high-speed substation protection applications, interlocking and intertripping.

The engineering of a solution for a power automation part in the power generation facilities and electric power transformation substations is characterized by the usage of many different tools for different purposes from different organizational units, and complex and highly iterative workflows. Often, it is required that project specific solutions are created from scratch and for each individual component within the project.

### SUMMARY

An exemplary embodiment of the present disclosure provides a method for bay typical based IEC 61850 engineering and integration to be used for automation plants. The exemplary method includes distributing functional parts of each bay typical across tools by using unique identifiers. An identification of a tool's specific functional part of a bay typical is based on the unique identifier.

An exemplary embodiment of the present disclosure provides a system for bay typical based IEC 61850 engineering and integration to be used for automation plants. The exemplary system includes a distribution unit configured to distribute functional parts of each bay typical across tools by using unique identifiers. An identification of a tool's specific functional part of a bay typical is based on the unique identifier.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a single line diagram of medium voltage switchgear for power distribution in a plant according to an exemplary embodiment of the present disclosure;

FIG. 2 shows a single bay in context with different automation system components according to an exemplary embodiment of the present disclosure;

FIG. 3 shows tools in an engineering solution for a power automation part in a power plant including data exchange, according to an exemplary embodiment of the present disclosure;

FIG. 4 shows a setup of a bay typical for a motor feeder according to an exemplary embodiment of the present disclosure;

FIG. 5 shows a method for engineering with bay typicals based on a bay typical catalogue access exemplarily depicted for the IEC 61850 system configuration tool and the IEC 61850 IED configuration tool, according to an exemplary embodiment of the present disclosure;

FIG. 6 depicts a generalization of the example shown in FIG. 5; and

FIG. 7 shows alternative solutions or variations of the present disclosure.

### DETAILED DESCRIPTION

Engineering solutions for the power automation part with the characteristics as described above in the Background Information section is inefficient because high level components for engineering are not available, and it is often impossible to reuse solutions created for one project in a similar different project.

For example, in power generation facilities or in electric power transformation substations, a substation includes closely connected subparts with some common functionality. Examples are the switchgear between an incoming or outgoing line and a busbar, the bus coupler with its circuit breaker and related isolators and earthing switches, the transformer with its related switchgear between the two busbars representing the two voltage levels. A bay concept is provided to apply to one and a half breaker and ring bus substation arrangements by grouping the primary circuit breakers and associated equipment into a virtual bay. These bays include a power system subset to be protected such as a transformer or a line end, and the control of its switchgear has some common restrictions such as mutual interlocking or well-defined operation sequences. The identification of such subparts is important for maintenance purposes or for extension plans, for example, what is added if a new line is to be linked in. These subparts are called bays and may be managed by devices with the generic name “bay controller” and have protection systems called “bay protection”. The concept of a bay is described in IEC 61850-1 standard.

The present disclosure provides a new solution for engineering the power automation part which is characterized by the usage of many different purposes from different organizational units and by a simplified top-down engineering workflow as proposed by the standard IEC 61850. In addition, specific solutions are created based on high level reusable components, so called bay typicals using unique identifiers.

The method of the present disclosure for bay typical based IEC 61850 engineering and integration includes a concept for bay typicals which distributes functional parts of each bay typical across the tools and an identification of a tool's specific functional part of a bay typical based on a unique identifier with a version index for a life cycle support within the tool.

Typical tools are, for example, an IEC 61850 IED configuration tools, a process controller configuration tools, an alarm/event configuration tools and a DCS operations configuration tools.

The method is also provided for top-down engineering. In a top-down approach, an overview of the system is formulated, specifying but not detailing any first-level subsystems and each subsystem is then refined in yet greater detail, sometimes in many additional subsystem levels until the entire specification is reduced to base elements. The new method is based on the bay typicals and nested typicals for engineering integrated process and power automation solutions.

The inventive method for bay typical based IEC 61850 engineering and integration across tools, using unique identifiers (UI), renders engineering a solution for power automation more efficient.

The new method uses a bay typical catalogue which contains the bay typicals. All available bay typicals from the bay typical catalogue are loaded by a master tool. Within the master tool the required bays for the automation plant are instantiated from the available bay typicals and a complete system configuration description is created.

The master tool memorizes the bay typical from which each bay was instantiated by storing the bay typical's Unique Identifier with version index within the instantiated bay.

During an export of the system configuration description into a system configuration description file, all bays along with their attached unique identifiers and version index are stored in the file, which finally contains a list of all bay instances with assigned bay typicals from which it was created.

During an import of the system configuration description file by an importing slave tool, the bays are scanned by the slave tool and the assigned unique identifiers with a version index are read. This allows the slave tool to identify the correct bay typical.

After identification of the correct bay typical, the tool is provided to access and import its own configuration part from the bay typical catalogue for the bay to be configured.

The present disclosure also provides a system using the method for bay typical based IEC 61850 engineering and integration, which provides for the usage of many different tools for different purposes from organizational units and by a simplified top-down engineering workflow as proposed by the standard IEC 61850. Functional parts of each bay typical are distributed across the tools by using unique identifiers.

The system includes an IEC 61850 master tool, which loads all available bay typicals from the bay typical catalogue and is used for top-down engineering. The master tool interacts with slave tools, for example, an IEC 61850 IED configuration tool, a process controller configuration tool, an alarm/event configuration tool and a DCS operations configuration tool. The slave tools are used to configure the details of the components as engineered in the master tool. The master tool and the slave tools are all denoted as engineering tools and both tools could be part of the engineering workflow, but each tool has specific functionality. The master tool is provided for common engineering and the slave tool assigned engineering specifics.

The master tool memorizes the bay typical from which each bay was instantiated by storing the bay typical's unique identifier with version index within the instantiated bay.

During an export of the system configuration description into a system configuration description file, all bays along with their attached unique identifiers and version index, are stored, so that the file finally contains a list of all bays with assigned bay typicals.

During an import of the system configuration description file an importing slave tool scans the bays and reads the assigned unique identifiers and optional with a version index to allow the slave tool to identify the correct bay typical.

After an identification of the correct bay typical, the slave tool accesses and imports its own configuration part from the bay typical catalogue to configure the bay's component covered by the tool.

In summary, to apply the new method and system for bay typical based engineering the following requirements are fulfilled:

A bay typical catalogue is provided and contains several bay typicals, wherein each bay typical includes a unique identifier with a version index and tool specific parts describing component configurations relevant for a bay instantiated from the bay typical.

A master tool is provided in which the system configuration takes place and which fulfills the following requirements:

The master tool is provided to import and export the complete bay typical catalogue.

The master tool allows instantiations of bays from bay typicals.

The master tool is provided to store a unique identifier with a version index of the bay typical along with each bay instantiated from this bay typical.

The master tool is provided to export a system configuration description file which contains an assignment of bays to their respective bay typical.

Several slave tools exist which import the system configuration description file as basis for component specific configurations and fulfill the following requirements:

Each slave tool is provided to support component specific configurations based on some sort of templates.

Each slave tool is provided to read a bay typical's unique identifier with a version index, accessing the bay typical catalogue, and importing the tool specific template from the identified bay typical.

With the new method and system for bay typical based IEC 61850 engineering and integration using unique identifiers, engineering a solution for the power automation part becomes more efficient.

In case of using protection and control devices, also called intelligent electronic device (IED's) in a project's power automation part a top down engineering as proposed by IEC 61850 is realized.

By generalizing the typical based approach, it is possible to create high level automation components to be used in automation engineering, such as, for example, a component describing a feed-water pump in a thermal power plant including an electrical part for power supply and an automation part for control and monitoring of the pump. Using this approach, engineering solutions for integrated process and power automation will be based on the same concept.

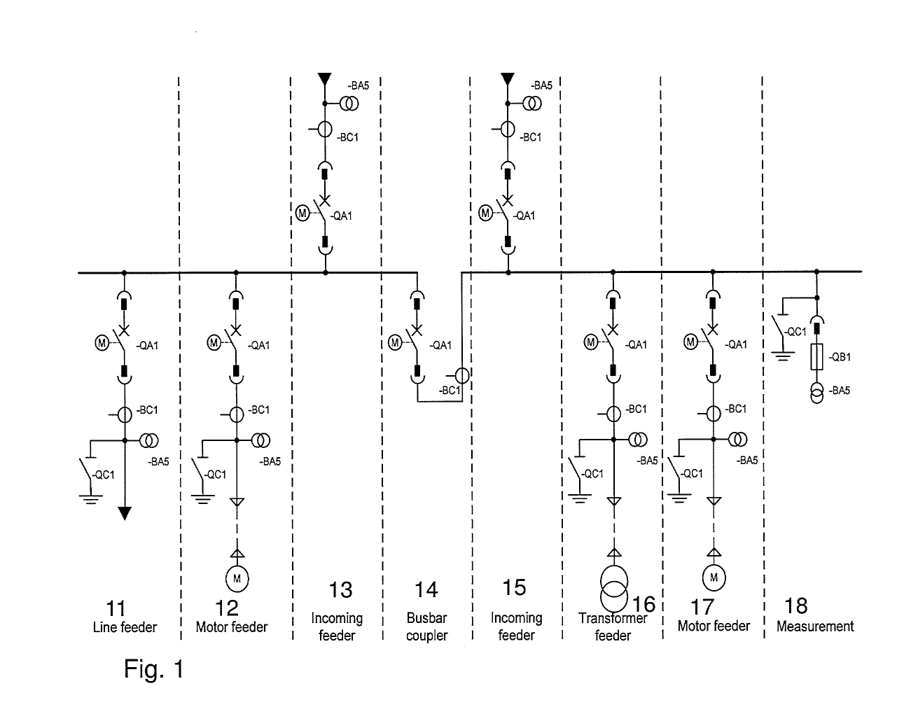

FIG. 1 presents an exemplary single line diagram of medium voltage switchgear for power distribution in a plant. In the state of the art average medium voltage switchgear for power distribution in a plant usually includes approximately 100 bays which are based on 10 different bay typicals.

The medium voltage switchgear shown in FIG. 1 is composed of several bays 11, 12, 13, 14, 15, 16, 17, 18, separated by slashed lines. Each bay holds primary equipment like circuit breakers, disconnectors, earthing switches, current and voltage transformers for measurement, etc. and serves a particular electrical application purpose as denoted below each bay. Within medium voltage switchgear, there may be several bays having the same electrical application purpose, like a motor feeder 12, 17 or an incoming feeder 13, 15, shown in FIG. 1.

All bays 11, 12, 13, 14, 15, 16, 17, 18 serving the same electrical application purpose are instances of a same bay typical, so there are usually less Bay typicals for the medium voltage switchgear than bays.

For protection, remote control and supervision of the primary equipment in medium voltage switchgear each bay 11, 12, 13, 14, 15, 16, 17, 18 has to be equipped with appropriate control and protection devices (IEDs) and these devices need to be connected to a central automation system for data exchange. This solution is called power automation.

In real projects, many bays 11, 12, 13, 14, 15, 16, 17, 18 are connected to one process controller 20 and one Data Acquisition and Alarm/Event Server 21. Data exchange between the intelligent electronic devices IED, process controller 20, Data Acquisition and Alarm/Event Server 21 and the operation station 22 is realized by Industrial Ethernet network(s) IEN.

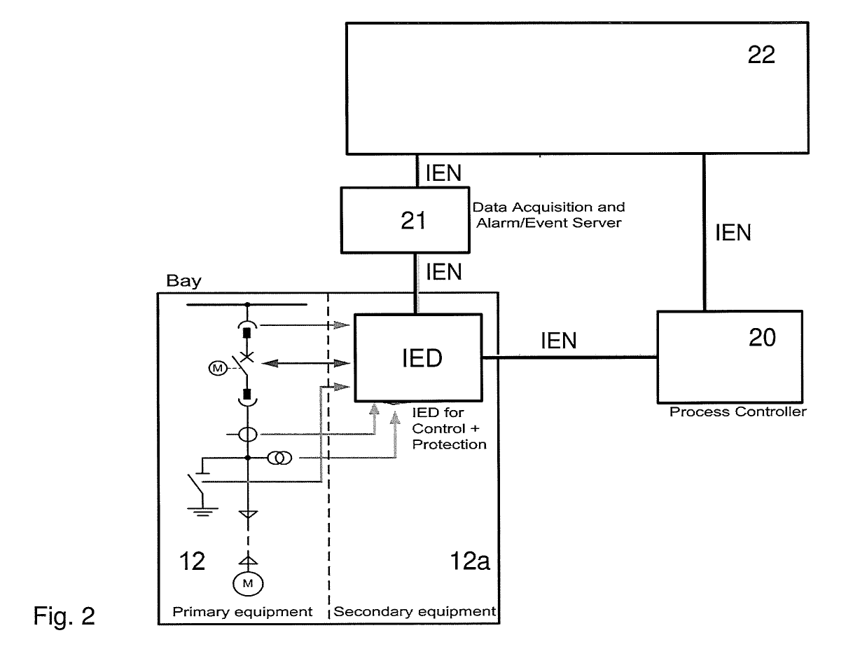

FIG. 2 depicts a single bay “Motor feeder” 12 as shown in FIG. 1 in the context of different automation system components, like a process controller 20, a data acquisition and alarm/event server 21 and an operation station 22.

In this example the bay 11 is equipped with one or several intelligent electronic devices IED responsible for control and protection of the primary equipment contained in the bay 12. All equipment serving control and protection purposes within the bay 12 are denoted as secondary equipment 12a. For remote control and supervision, the intelligent electronic devices IED exchange data with the different components 20, 21, 22 of the automation system over industrial Ethernet IEN. The process controllers 20 take over centralized automation tasks like load shedding. Data Acquisition and Alarm/Event servers provide a gateway to the operator station 22. Operations finally provide the appropriate workplaces (showing operator graphics and faceplates) for remote control and supervision of the medium voltage switchgear. Usually several (circa 80-100) intelligent electronic devices IED are connected to one data acquisition and alarm/event server 21 and to one process controller 20.

According the known techniques, the engineering of the solution as shown in FIG. 2 requires different tools for different purposes to implement a plant's power automation part.

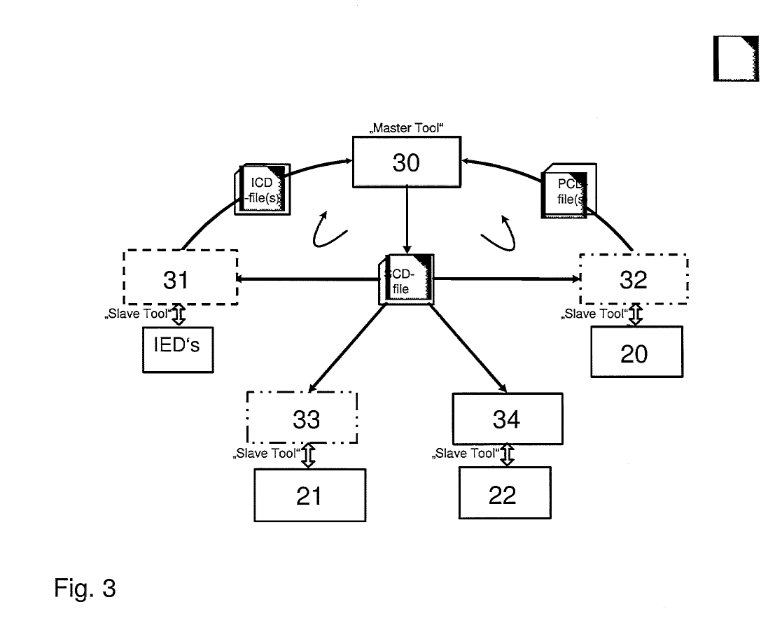

FIG. 3 depicts examples of tools used to engineer the power automation part for a plant including data exchange between the IED's and the automation system components 20, 21, 22. The IEC 61850 system configuration tool 30 acts as “Master tool”. All the other tools, like IEC 61850 IED configuration tool 31, process controller configuration tool 32, alarm and event configuration tool 33, and DCS operations configuration tool 34 are required to configure the different components IED's 20, 21, 22, shown in FIG. 2 and are denoted as “Slave tools”.

The IEC 61850 system configuration tool 30 is provided to specify a plant's power distribution including primary equipment, IEDs, communication network, and data exchange between IEDs themselves, IEDs and process controllers 20, as well as between IEDs and alarm and event system 21. The IEC 61850 IED configuration tool 31 provides the IED capability descriptions as input to the IEC 61850 system configuration tool 30 and configures the IED instances as specified within the IEC 61850 system configuration tool 30. The process controller configuration tool 32 is provided to configure the process controller 20 as IED and provide its IED capability description as input to the IEC 61850 system configuration tool 30 and to configure the process controller's data exchange with IEDs as specified within the IEC 61850 system configuration tool 30. The DCS operations configuration tool 34 is provided to configure the data presentation and operations part of the distributed automation system as specified within the IEC 61850 system configuration tool 30 and the alarm and event configuration tool 33 is provided to configure alarms and events based on communication between IEDs and process automation system as specified within the IEC 61850 system configuration tool 30. So the IEC 61850 system configuration tool 30 acts as a “Master tool” and consumes input ICD-files from the IEC 61850 IED configuration tool describing the capabilities of the IEDs as well as input PCD-files from the process controller configuration tool describing the capabilities of the process controller 20. Based on this input, the complete power distribution part of the plant is specified within the IEC 61850 system configuration tool 30. This specification is finally exported in the system configuration description file SCD.

The specification of the present disclosure includes the following parts. Specification of all bays 11, 12, 13, 14, 15, 16, 17, 18 as single line diagram and their assigned primary equipment contained in a medium voltage switchgear (compare to FIG. 1), and specification of all I EDs contained in each bay 11, 12, 13, 14, 15, 16, 17, 18 for control, measurement, protection and power management purposes, communication network setup with all IEDs, process controllers 20 and data acquisition and alarm/event equipment 21 connected to it, data flow, i.e. data exchange between IEDs, process Controllers 20 and data acquisition and alarm/event equipment 21.

The system configuration description (SCD)-file is imported by the other involved tools, called “Slave Tools” 31, 32, 33, 34 and serves as basis to configure the different components IED, 20, 21, 22. Because the system configuration description file does not contain all details required to completely configure each component, in each tool additional configuration (carried out manually) has to take place.

Currently, the engineering takes place on bay level, i.e. each bay 11, 12, 13, 14, 15, 16, 17, 18 has to be engineered separately and in case of changes affecting the system configuration description file, the configuration of all components has to be repeated manually for each bay. This renders engineering inefficient.

The following drawings show an inventive solution to make the engineering more efficiently. The main idea behind the present disclosure is to do the engineering on bay typical level and instantiate the different bays 11, 12, 13, 14, 15, 16, 17, 18 automatically, instead of doing the engineering on bay level instances.

To stay with the illustrations given in FIG. 1, only 10 bay typicals would have to be engineered per medium voltage switchgear instead of 100 bays and changes made to a bay typical could be propagated to all of its instances (bays) automatically. Additionally the data presentation, operations section and the alarm/ event configuration will be achieved. This increases engineering efficiency in a favorable way.

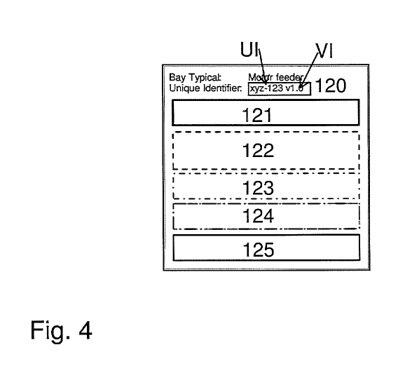

The basis for the present disclosure is a concept for bay typicals covering the configuration required for all involved components (see FIG. 2) addressed in their respective engineering tools (see FIG. 3). Following the components shown in FIG. 2, a bay typical includes the parts depicted in FIG. 4.

FIG. 4 shows an exemplary setup of a bay typical 120 for a motor feeder. According to an exemplary embodiment of the present disclosure, each bay typical is identified by a unique identifier UI and/or a version index VI, exemplary for a life cycle support and includes several parts, for example, a bay layout template incl. primary equipment and data definitions 121, an IED configuration template incl. control, measurement, protection and power management function 122, a function block/bay control module 123, an alarm/event configuration template 124 and/or a bay object type including graphics, elements and faceplate 125.

Each part (templates, function block, object type) 121, 122, 123, 124, 125 covers the complete configuration for a bay derived from the bay typical 120 within each tool involved in engineering (for example, the part bay layout template 121 matches the system configuration tool 30, the part IED configuration template 122 matches the configuration tool 31, the part function block/bay control module 123 matches the process controller configuration tool 32, the part alarm/event configuration template 124 matches the alarm and event configuration tool 33 and the part of DCS operations configuration tool 34 matches the elements and faceplate 125 in FIG. 3).

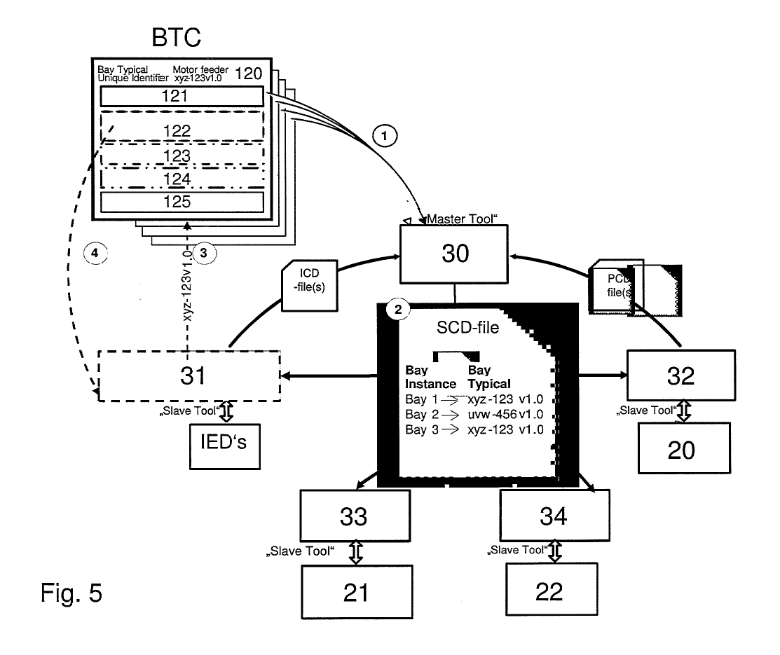

FIG. 5 shows a method for engineering with bay typicals based on a bay typical catalogue access exemplary depicted for the IEC 61850 system configuration tool 30 and the IEC 61850 IED configuration tool 31. A bay typical catalog BTC includes a plurality of bay typicals 120.

To cover complete medium voltage switchgear, the catalogue BTC with different bay typicals 120 is defined. The bay typical catalogue BTC is then accessed by the engineering tools as depicted in FIG. 5 for the IEC 61850 system configuration tool 30 and the IEC 61850 IED configuration tool 31. All remaining tools 32, 33, 34 access the bay typical catalogue BTC in the same way like depicted for the IEC 61850 IED configuration tool 31.

The method for engineering based on the bay typicals 120 according to the present disclosure follows the following approach:

In an optional step, the engineering starts by creating or adapting the bay typical catalogue BTC relevant for a project.

In first step, 1 the IEC 61850 system configuration tool 30, as a master tool, loads all available bay typicals 120 from the bay typical catalogue BTC and offers them for engineering. Then, all required bays 11, 12, 13, 14, 15, 16, 17, 18 for medium voltage switchgear are instantiated from the available bay typicals to complete the system configuration. The tool memorizes (e.g., records in a non-transitory computer-readable recording medium resident therein) the bay typical 120 from which each bay 11, 12, 13, 14, 15, 16, 17, 18 was instantiated by storing the bay typical's Unique Identifier UI with version index VI within the instantiated bay along with each bay's specific configuration. The tool can include a general-purpose or application specific processor configured to execute a computer program or instructions tangibly recorded on a non-transitory computer-readable recording medium, such as a ROM, hard disk drive, flash memory, optical memory, etc.

During the export of the system configuration description file from the system configuration, all bays 11, 12, 13, 14, 15, 16, 17, 18 along with their attached unique identifiers UI and version index VI are stored in the file in the second step 2. So the file contains a list of all bays 11, 12, 13, 14, 15, 16, 17, 18 with assigned bay typicals.

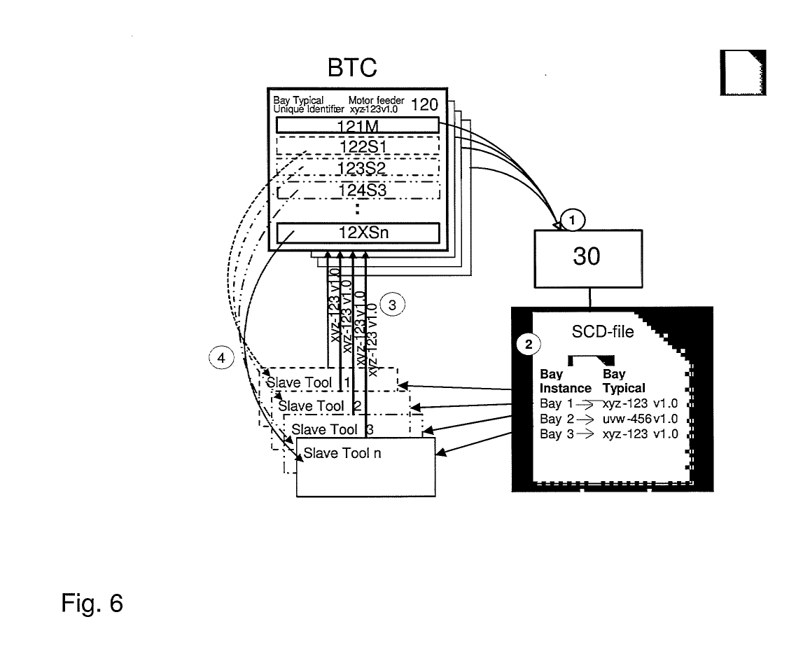

In a next step 3 during import of the system configuration description file SCD into a slave tool 31, the slave tool 31 scans the bays 11, 12, 13, 14, 15, 16, 17, 18 and reads the assigned unique identifiers UI. With the unique identifiers UI the slave tool 31 accesses the correct bay typical in the bay typical catalogue BTC for each bay 11, 12, 13, 14, 15, 16, 17, 18. (Step 3 in FIG. 5 as depicted for the IEC 61850 IED configuration tool 31; the same applies to all other tools as process controller configuration tool 32, alarm and event configuration tool 33 and DCS operations configuration tool 34—see FIG. 6).

After identification of the correct bay typical, the slave tool 31 imports its own configuration part from the bay typical catalogue BTC for the bays 11, 12, 13, 14, 15, 16, 17, 18 (step 4 in FIG. 5 as depicted for the IEC 61850 IED configuration tool 31; the same applies to all other tools as process controller configuration tool 32, alarm and event configuration tool 33 and DCS operations configuration tool 34—see FIG. 6).

FIG. 6 depicts a generalization of the example shown in FIG. 5. The inventive method and system can be applied to all areas where a system specification is carried out in a master tool 30 and the different system components are configured using different slave tools 1, 2, 3 . . . n by using the master tool configuration 121M, the first slave tool configuration data template 12251, the second slave tool configuration data template 12352, the third configuration data template 12453 and so on to the n-th slave tool configuration data template 12×Sn integrated in the bay typical catalogue BTC.

Instead of a “Bay Typical Catalogue” BTC, one can speak of a generic “Object Typical Catalogue” and instead of a “Bay Typical” the term “Object Typical” can be used. The term “bay” is finally replaced by “object”. The requirements given at the end of the previous section stay valid using the rephrasing introduced above.

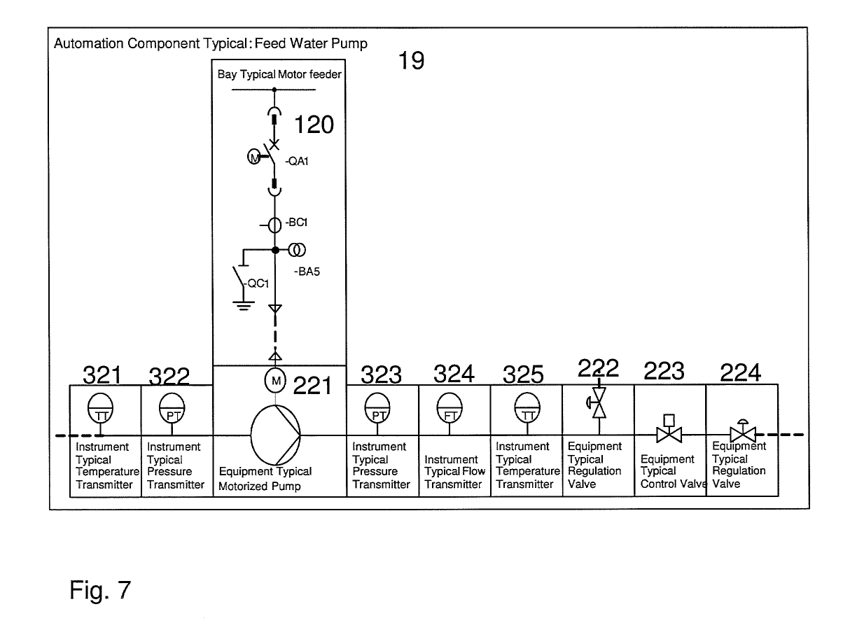

FIG. 7 refers to alternative solutions or variations of the present disclosure using the example of an automation component typical. The automation component typical “Feed Water Pump” 19 includes nested typicals from different domains.

The electrical part of the “Feed Water Pump” is represented by a bay typical “Motor Feeder” 120 introduced in FIG. 4. The process equipment is represented by equipment typicals for a motorized pump 221 and different types of valves 222, 223, 224. Finally, measurements are represented by different instrument typicals 321, 322, 323, 324, 325. How the components represented by these nested typicals are interconnected and how they are controlled is described in the automation component typical 19.

In an alternative embodiment of the present disclosure, the typical based approach is realized in an integrated engineering framework instead of separate tools. Here, the functionality of the master tool 30 and all slave tools 1, 2, 3 . . . n are part of one common framework with centralized data storage.

To engineer solutions for the integrated process and power automation the power automation part as well as the process automation part is considered. Both parts are engineered in a common approach using the following types of typicals, all following the generalized idea as sketched in FIG. 6. bay typicals (as introduced in detail in the description of FIGS. 1-5) to represent the electrical part, equipment typicals 221 to represent process equipment, instrument typicals 321, 322, 323, 324, 325 to represent process measurements, power management typicals to balancing power consumption against process outcome.

Typicals of these types can be nested to create high level automation components, like a feed water pump as shown in FIG. 7. The resulting “Meta”-Typical is denoted as an “Automation Component Typical”. It represents the equipment, devices, process functionalities, electrical behaviors, and control aspects of such a complex automation component. Automation component typicals can also be used with the generalized embodiment shown in FIG. 6. The master tool 30 has just to fulfill one additional requirement. It must be capable to resolve the nested typicals. Using automation component typicals during engineering will further reduce engineering effort within a project and allows reuse across projects of similar types like power plants, for example.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for bay typical based IEC 61850 engineering and integration to be used for automation plants, the method comprising:
distributing functional parts of each bay typical across tools by using unique identifiers,
wherein an identification of a tool's specific functional part of a bay typical is based on the unique identifier.

2. The method according to claim 1, wherein the identification of a tool's specific functional part of a bay typical is based on the unique identifier together with a version index for a life cycle support within the tool.

3. The method according to claim 1, wherein the tools include an IEC 61850 system configuration tool, an IEC 61850 IED configuration tool, a process controller configuration tool, an alarm/event configuration tool and a DCS operations configuration tool.

4. The method according claim 1, comprising:
providing a bay typical catalogue for bays with several bay typicals;
loading all available bay typicals from the bay typical catalogue by an IEC 61850 master tool;
instantiating required bays for the automation plant from the available bay typicals and creating a complete system configuration description;
recording in the master tool the bay typical from which each bay is instantiated by storing a bay typical's unique identifier with a version index within the instantiated bay;
during an export of the system configuration into a system configuration description file, storing all bays along with their attached unique identifiers and version index in the system configuration description file, which contains a list of all bay instances with assigned bay typicals from which it was created,
during an import of the system configuration description file into a slave tool, scanning the bays by the slave tool and reading the assigned unique identifiers with a version index;
importing, with the unique identifiers, the correct bay typical in the bay typical catalogue for each bay from the system configuration description file by the slave tool; and
after an identification of the correct bay typical, providing the slave tool to access and import its own configuration part from the bay typical catalogue for the bay.

5. The method according to claim 2, wherein the tools include an IEC 61850 system configuration tool, an IEC 61850 IED configuration tool, a process controller configuration tool, an alarm/event configuration tool and a DCS operations configuration tool.

6. The method according claim 5, comprising:
providing a bay typical catalogue for bays with several bay typicals;
loading all available bay typicals from the bay typical catalogue by an IEC 61850 master tool;
instantiating required bays for the automation plant from the available bay typicals and creating a complete system configuration description;
recording in the master tool the bay typical from which each bay is instantiated by storing a bay typical's unique identifier with a version index within the instantiated bay;
during an export of the system configuration into a system configuration description file, storing all bays along with their attached unique identifiers and version index in the system configuration description file, which contains a list of all bay instances with assigned bay typicals from which it was created,
during an import of the system configuration description file into a slave tool, scanning the bays by the slave tool and reading the assigned unique identifiers with a version index;
importing, with the unique identifiers, the correct bay typical in the bay typical catalogue for each bay from the system configuration description file by the slave tool; and
after an identification of the correct bay typical, providing the slave tool to access and import its own configuration part from the bay typical catalogue for the bay.

7. A system for bay typical based IEC 61850 engineering and integration to be used for automation plants, the system comprising:
a distribution unit configured to distribute functional parts of each bay typical across tools by using unique identifiers,
wherein an identification of a tool's specific functional part of a bay typical is based on the unique identifier.

8. The system according claim 7, comprising:
an IEC 61850 master tool which is configured to interact with slave tools, wherein:
the IEC 61850 master tool is configured to load all available bay typicals from a bay typical catalogue containing several bay typicals;
a complete system configuration description is a result of an instantiation of the required bays for the automation plant from the available bay typicals;
the master tool is configured to record therein the bay typical from which each bay is instantiated by storing a bay typical's unique identifier with a version index within the instantiated bay;
during the export of the system configuration into a system configuration description file all bays along with their attached unique identifiers and version index are stored in the system configuration description file such that the system configuration description file contains a list of all bay instances with assigned bay typicals, from which it was created;
during an import of the system configuration description file, an importing slave tool is configured to scan the bays and read the assigned unique identifiers with a version index;
with the unique identifiers, the slave tool is configured to access a correct bay typical in the bay typical catalogue for each bay; and
after an identification of the correct bay typical, the slave tool is configured to access and import its own configuration part from the bay typical catalogue for the bay.

9. The system according to claim 7, wherein the system configuration description file includes a specification of all bays as a single line diagram and their assigned primary equipment, a specification of all intelligent electronic devices (IEDs) contained in each bay, a communication network setup with all IEDs, process controllers and data acquisition and alarm/event equipment connected to it and a data flow including data exchange between IEDs, the process controllers and data acquisition and alarm/event equipment.

10. The system according to claim 8, wherein:
the master tool is configured to import and export a complete bay typical catalogue, allow instantiations of the bays from the bay typicals, store the unique identifier with the version index of the bay typical along with each bay instantiated from this bay typical, and export the system configuration description file which contains an assignment of bays to their respective bay typical.

11. The system according to claim 10, wherein the slave tools are configured to import the system configuration description file as a basis for component specific configurations and fulfill the following requirements:
each slave tool is configured to support component specific configurations based on tool specific templates; and
each slave tool is configured to read a bay typical's unique identifier with a version index, access the bay typical catalogue, and import the tool specific template from the identified bay typical.

12. The system according to claim 8, wherein the slave tools are configured to import the system configuration description file as a basis for component specific configurations and fulfill the following requirements:
each slave tool is configured to support component specific configurations based on tool specific templates; and
each slave tool is configured to read a bay typical's unique identifier with a version index, access the bay typical catalogue, and import the tool specific template from the identified bay typical.

13. The system according to claim 7, wherein the typicals are at least one of bay typicals configured to represent an electrical part of the plant, equipment typicals configured to represent process equipment, instrument typicals configured to represent process measurements, and power management typicals configured to balance power consumption against process outcome.

14. The system according to claim 11, wherein the typicals are at least one of bay typicals configured to represent an electrical part of the plant, equipment typicals configured to represent process equipment, instrument typicals configured to represent process measurements, and power management typicals configured to balance power consumption against process outcome.

15. The system according to claim 12, wherein the typicals are at least one of bay typicals configured to represent an electrical part of the plant, equipment typicals configured to represent process equipment, instrument typicals configured to represent process measurements, and power management typicals configured to balance power consumption against process outcome.

16. The system according to claim 7, wherein the bay typicals and nested typicals are provided for an engineering integrated process and power automation solutions.

17. The method according to claim 1, wherein the bay typicals and nested typicals are provided for an engineering integrated process and power automation solutions.
